(19) United States
(12) Patent Application Publication
(10) Pub. No.: US 2019/0005841 A1
(43) Pub. Date: Jan. 3, 2019

(54) REPRESENTATION OF GROUP EMOTIONAL RESPONSE

(71) Applicant: INTEL CORPORATION, Santa Clara, CA (US)

(72) Inventors: Daria A. Loi, Portland, OR (US); Ramune Nagisetty, Portland, OR (US); Pete A. Denman, Portland, OR (US); Glen J. Anderson, Beaverton, OR (US)

(73) Assignee: INTEL CORPORATION, Santa Clara, CA (US)

(21) Appl. No.: 15/639,361

(22) Filed: Jun. 30, 2017

(51) Int. Cl. G09B 19/00; H04L 12/58; G06T 11/20; G06T 11/60; G09B 5/04; G09B 5/02

(52) U.S. Cl. CPC G09B 19/00; H04L 51/22; G09B 5/02; G06T 11/60; G09B 5/04; G06T 11/206

(57) ABSTRACT

One embodiment provides an apparatus. The apparatus includes a group response logic. The group response logic is to determine a respective user emotional response to a relevant content provided to each user of a plurality of users. The respective emotional response is determined based, at least in part, on a respective user objective data captured for each user in response to exposure of each user to the relevant provided content. The relevant content is provided to at least some of the plurality of users across at least one of a plurality of points in time and/or a plurality of locations. The group response logic is further to aggregate a plurality of respective user emotional responses to yield a first aggregated emotional response.

### FIELD

The provide disclosure relates to emotional response, in particular, to representation of a group emotional response.

### BACKGROUND

Emotion is typically thought about in relation to an individual: a person experiences emotions that change in form and intensity over time. Group emotions are distinct from an individual's emotions, may depend on the person's degree of group identification, may be socially shared within a group, and may contribute to regulating intragroup and intergroup attitudes and behavior.

### BRIEF DESCRIPTION OF DRAWINGS

Features and advantages of the claimed subject matter will be apparent from the following detailed description of embodiments consistent therewith, which description should be considered with reference to the accompanying drawings, wherein:

FIG. 1 illustrates a functional block diagram of a group emotional response system consistent with several embodiments of the provide disclosure; and

FIG. 2 a flowchart of group emotional response operations according to various embodiments of the provide disclosure.

Although the following Detailed Description will proceed with reference being made to illustrative embodiments, many alternatives, modifications, and variations thereof will be apparent to those skilled in the art.

### DETAILED DESCRIPTION

Generally, this disclosure relates to a group emotional response representation system. An apparatus, method and/or system are configured to determine, aggregate and display a group (i.e., aggregated) emotional response. The apparatus, method and/or system are configured to facilitate viewing of emotional response and/or emotional trends by group membership, content, and timing. As used herein, “timing” corresponds to a point in time of exposure to content. As used herein, “relative timing” corresponds to a time difference between a first point in time and a second, later, point in time.

Co-members of a group may view a group emotional response to, for example, online content that some or all of the members have been provided. The co-members, i.e., users, may be provided the content across at least one of a plurality of points in time and/or a plurality of locations. Each user emotional response may be determined based, at least in part, on captured user objective data. User objective data may include, but is not limited to, user physiological data (e.g., biometrics) and/or environmental data.

The apparatus, method and/or system includes a group response logic. The group response logic is to determine a respective user emotional response to a relevant content provided to each user of a plurality of users. The respective emotional response is determined based, at least in part, on a respective user objective data captured for each user in response to exposure of each user to the relevant provided content. The relevant content is provided to at least some of the plurality of users across at least one of a plurality of points in time and/or a plurality of locations. The group response logic is further to aggregate a plurality of respective user emotional responses to yield a first aggregated emotional response.

Individual emotional response to given content may be determined by fusing and analyzing features extracted through diverse sensing capabilities (e.g. 2D/3D cameras, microphones, physiological sensors) that are typically embedded in devices on/around and used by users (e.g. wearables, smartphones, tablets, laptops). Each individual emotional response may be collected and tagged to facilitate group level analytics to estimate, map and visualize aggregate user emotional response to provided content.

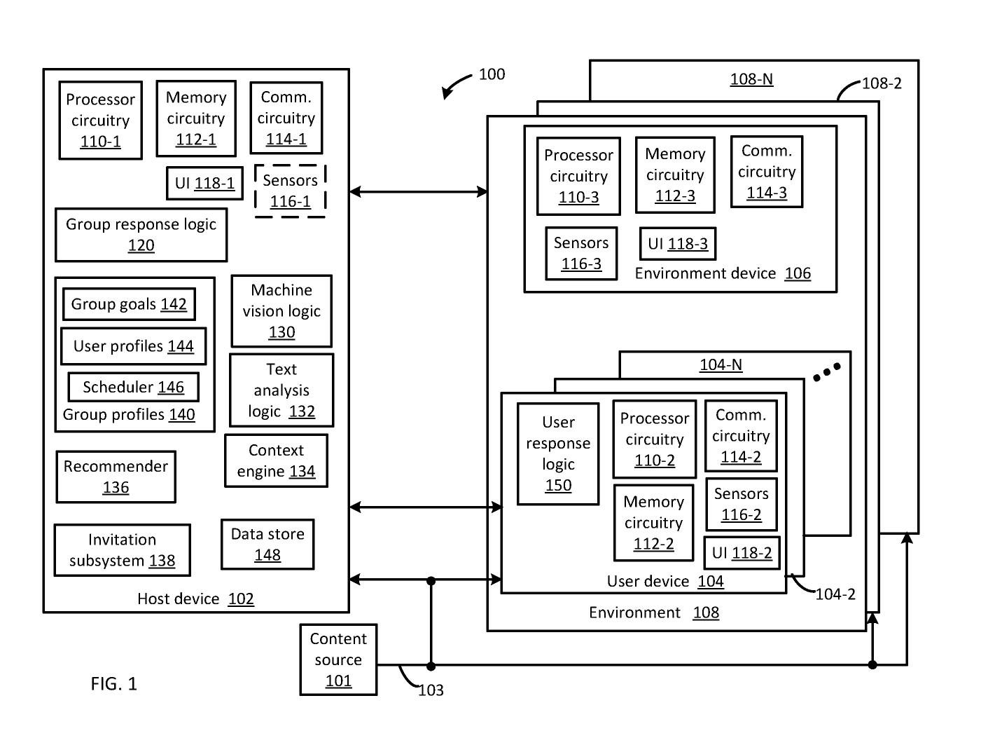

FIG. 1 illustrates a functional block diagram of a group emotional response system 100 consistent with several embodiments of the provide disclosure. FIG. 1 further illustrates a content source 103. The group emotional response system 100 includes a host device 102 and one or more environments 108, 108-2, . . . , 108-N. Each environment, e.g., environment 108, includes one or more user devices 104, 104-2, . . . , 104-N, and an environment device 106. In an embodiment, host device 102 may correspond to a user device. In an embodiment, host device 102 may be coupled to an environment, e.g., environment 108, and thus, one or more user devices, e.g., user devices 104, 104-2, . . . , 104-N, and an environment device, e.g., environment device 106.

Host device 102 may include, but is not limited to, a computing system (e.g., a server, a workstation computer, a desktop computer, a laptop computer, a tablet computer (e.g., iPad®, GalaxyTab® and the like), an ultraportable computer, an ultramobile computer, a netbook computer and/or a subnotebook computer; etc.

User devices, e.g., user device 104, may include, but are not limited to, a mobile telephone including, but not limited to a smart phone (e.g., iPhone®, Android®-based phone, Blackberry®, Symbian®-based phone, Palm®-based phone, etc.); a wearable device (e.g., wearable computer, “smart” watches, smart glasses, smart clothing, etc.) and/or system; an Internet of Things (IoT) networked device including, but not limited to, a sensor system (e.g., environmental, position, motion, etc.) and/or a sensor network (wired and/or wireless); a computing system (e.g., a server, a workstation computer, a desktop computer, a laptop computer, a tablet computer (e.g., iPad®, GalaxyTab® and the like), an ultraportable computer, an ultramobile computer, a netbook computer and/or a subnotebook computer; etc.

Environment device 106, may include, but is not limited to, a mobile telephone including, but not limited to a smart phone (e.g., iPhone®, Android®-based phone, Blackberry®, Symbian®-based phone, Palm®-based phone, etc.); an Internet of Things (IoT) networked device including, but not limited to, a sensor system (e.g., environmental, position, motion, cameras (two dimensional and/or three dimensional), microphones, etc.) and/or a sensor network (wired and/or wireless), a vehicle navigation system (e.g., global positioning system (GPS)); a computing system (e.g., a server, a workstation computer, a desktop computer, a laptop computer, a tablet computer (e.g., iPad®, GalaxyTab® and the like), an ultraportable computer, an ultramobile computer, a netbook computer and/or a subnotebook computer; etc.

In one embodiment, host device 102 may correspond to a cloud-based server or edge server. In another embodiment, host device 102 may correspond to a user device in, for example, a peer-to-peer architecture.

In the following, for efficiency of description, user device 104 and environment 108 are described. Similar descriptions may apply to any one or more of user devices 104-2, . . . , 104-N and/or environments 108-2, . . . , 108-N.

Each device 102, 104, 106 includes a respective processor 110-1, 110-2, 110-3, a memory circuitry 112-1, 112-2, 112-3, a communication circuitry 114-1, 114-2, 114-3 and/or a user interface (UI) 118-1, 118-2, 118-3. User device 104 and/or environment device 106 may each include one or more sensors 116-2, 116-3, respectively. For embodiments where host device 102 corresponds to a user device, host device 102 may include sensors 116-1. For example, processor circuitry 110-1, 110-2, 110-3 may correspond to a single core or a multi-core general purpose processor, such as those provided by Intel® Corp., etc. In another example, processor circuitry 110-1, 110-2, 110-3 may include, but is not limited to, a microcontroller, an application-specific integrated circuit (ASIC), a programmable logic device (PLD), a complex PLD, etc.

Sensors 116-1, 116-2, 116-3 may include, but are not limited to, physiological sensors (e.g., sensors configured to capture and/or detect one or more of temperature, heart rate, variation in heart rate, pupil dilation, respiration rate, galvanic skin resistance (e.g., sweating), blood pressure, brain activity (e.g., electroencephalogram (EEG)), microphone(s) configured to capture voice, environmental sensors (e.g., sensors configured to capture motion, acceleration, vibration, tactile, conductance, force, proximity, location sensing, eye tracking), a camera (e.g., two dimensional, three-dimensional, depth) configured to capture, e.g., facial expressions, posture and/or gestures, a microphone configured to capture, e.g., audio, speech, voice (including pitch of voice and/or tone of voice), etc. Thus, sensors 116-1, 116-2, 116-3 are configured to capture and/or detect physiological and/or environmental data related to a user's response to a content 103 provided to the user by the system 100.

User interface 118-1, 118-2, 118-3 may include, but is not limited to, one or more of an output device (e.g., a display, a touch sensitive display, a speaker, a tactile output, projector, etc.) and/or an input device (e.g., a mouse, a touchpad, a keyboard, a keypad, a touch sensitive display, a microphone, a camera (video and/or still), etc.).

Host device 102 may further include a group response logic 120, a machine vision logic 130, a text analysis logic 132, a context engine 134, group profiles 140, a recommender 136, an invitation subsystem 138 and a data store 148. Group profiles 140 may include group goals 142, user profiles 144 and a scheduler 146, for a plurality of groups of users. The group response logic 120 is configured to perform operations associated with determining an aggregated emotional response for a plurality of users, as will be described in more detail below.

User device 104 may further include a user response logic 150. User response logic 150 is configured to perform operations associated with capturing user objective data and displaying a group emotional response to the user. The user response logic 150 may facilitate providing content to the user and/or capturing live content provided to the user. User response logic 150 is configured to capture sensor data related to a user response to provided content. For example, user response logic 150 may be configured to capture sensor data from user device sensors 116-2 and/or environment sensors 116-3.

The machine vision logic 130 may be configured to identify objects included in a visual display of provided content. The machine vision logic 130 may be further configured to identify and tag a region of text in a visual display of provided content that includes a plurality of regions of text. The regions of text may include, but are not limited to, one or more title blocks and/or one or more bodies (e.g., paragraphs) of text, one or more links to other websites displayed on a webpage, blog postings, etc.

The text analysis logic 132 is configured to identify textual content. The text analysis logic 132 may be further configured to perform natural language processing (e.g., sentiment analysis) of the identified textual content to extract sentiment.

The context engine 134 may be configured to identify user context (e.g., location, time of day, who else is present) when the user is exposed to the provided content.

The recommender 136 may be configured to provide recommendations to other group members based, at least in part, on an aggregated emotional response to relevant provided content. As used herein, “group members” corresponds to a plurality of users with a common interest and/or a common group membership.

Invitation subsystem 138 may be configured to invite one or more other group members to experience the relevant provided content. In one nonlimiting example, the invitation may be based, at least in part, on each corresponding other user profile. In another nonlimiting example, the invitation may be based, at least in part, on the current aggregated emotional response to the provided content.

The data store 148 may be configured to store data related to operation of the group emotional response system 100. The data store 148 may be configured to store one or more of content metadata, user metadata, individual user emotional response associated with a provided content identifier, and/or an aggregated emotional response associated with one or more of a location identifier, one or more provided time indicator(s) corresponding to each respective point in time that the relevant content was provided and/or selected user metadata. Content metadata is configured to identify content, time that the content was provided, location where the content was provided and/or content characteristics, e.g., names of actors in a movie, etc. User metadata is configured to include user specific information related to exposure to provided content, e.g., location and/or timing of exposure.

Group profiles 140 may include group goals 142, user profiles 144 and a scheduler 146, for a plurality of groups of users. Group goals 142 may include, but are not limited to, a desire to seek a level of relaxation or to call attention to something that elicited a strong response from others in the group.

The user profiles 144 may include, for each user, a user social group membership information, a user preference, a previous user behavior, a current emotional state, a specific context and/or one or more user policies. The user social group membership information may include a list of social group identifiers for social groups to which the user belongs. Social groups may include, but are not limited to, one or more of an email thread, a social group membership list, a social media group thread, a formal online-based group, a formal online-based association. A social group membership list may include, but is not limited to, members of a museum, individuals interested in space exploration (e.g., NASA voyages), etc. In some embodiments, user group membership may be ad hoc. User policy may include, but is not limited to, conditions for tracking objective data of a user, conditions associated with permission to aggregate a user emotional response, whether the user prefers direct user feedback for selecting tracking and/or aggregating, etc. In one nonlimiting example, each user profile may be created and/or updated based, at least in part, on combining data captured from a plurality of diverse interconnected devices, including, but not limited to, user device 104 and/or environment device 106 and/or elements thereof. Each user profile may be accessible and manually adjusted from, for example, user device 104, environment device 106 and/or host device 102.

User preference may include, but is not limited to, one or more rules related to one or more of a desired emotional state and/or a preferred stress range, one or more rules related to when a user response to provided content may be tracked (e.g., time of day, type of content, environment, intensity of user emotions, etc.), one or more rules related to when a user response may be aggregated, an indicator whether a user may be identified or should remain anonymous with an aggregated emotional response, a list of group identifiers for group(s) of which the user is a member, etc. The desired emotional state and/or preferred stress range may be utilized to determine whether or not to track the user's response to provided content. In one nonlimiting example, the user's emotional response to the provided content may not be tracked if the user's current stress level is outside the preferred stress range. In another nonlimiting example, the user's emotional response to the provided content may not be included in the aggregated emotional response, if the user's emotional response exceeds the desired emotional state.

Previous user behavior may include previous user emotional response(s) to provided content. Previous user behavior may be used by, e.g., user response logic 150 and/or group response logic 120 to refine decisions related to determining whether to track the user's emotional response and/or whether to aggregate the user's emotional response, as described herein. The user current emotional state may be determined based, at least in part, on user physiological data and/or environmental data captured by, e.g., sensors 116-2 and/or 116-3. Specific context may include, but is not limited to, a user location, a user environment and/or an indication of who else may be provide when the user is exposed to the provided content.

The scheduler 146 is configured to monitor and capture a respective point in time (“timing”) that the relevant content was provided to each user and/or group of users.

In operation, content source 101 may be configured to provide content 103 to host device 102. Content 103 may include, but is not limited to, audio content, one or more images, text, video content, webpages, online content, electronic documents, electronic presentations, blogs, etc. Host device 102 and/or content source 101 may then be configured to provide the content 103 to a plurality of users. For example, the content 103 may be provided to the plurality of users via respective user devices, e.g., user device 104 and user interface 118-2. In an embodiment, the content 103 may be provided to at least some of the plurality of users across at least one of a plurality of points in time and/or a plurality of locations. In other words, two or more users may be exposed to the provided content 103 at different points in time and/or at different locations.

In one embodiment, at least one user of the plurality of users may experience the provided content live. In this embodiment, the live content may be captured by host device 102 and/or user device 104. Live content may include, but is not limited to, a concert, a sporting event, a live show, a political rally, etc.

Host device 102, e.g., machine vision logic 130, text analysis logic 132 and/or context engine 134 may be configured to analyze the provided content 103 to generate associated content metadata. A content identifier and associated content metadata may then be stored to data store 148.

Group response logic 120 may then be configured to determine whether the provided content 103 is relevant to a selected group of users of the plurality of users. For example, whether the provided content 103 is relevant may be determined, based at least in part, on group profiles of the selected group of users included in group profile 140.

User response logic 150 may then be configured to determine whether a user response (e.g., user objective data and/or a user emotional response) of a user of user device 104 may be tracked. For example, whether the user response of the selected user may be tracked may be determined through one or more of a direct feedback loop (e.g., a pop up request or email request) or based, at least in part on previously logged preferences and/or behaviors and/or a user-determined policy. The previously logged preferences, behaviors and/or user-determined policy may be included in user profiles 144.

User response logic 150 may be configured to capture a respective user (for example, the user of user device 104) objective data in response to relevant provided content. Objective data may include, but is not limited to, captured physiological data and/or captured environmental data captured by sensors 116-2, 116-3. In one nonlimiting example, for a composite relevant provided content that includes a plurality of individual contents (e.g., a webpage with a plurality of text regions), user response logic 150 may be configured to capture selected objective data (e.g., eye tracking data, determining which window is on top, etc.) to identify one or more individual relevant contents that triggered a corresponding emotional response. The relevant content may be provided to a selected group of users (i.e., to each user of the selected group of users) across at least one of a plurality of points in time and/or a plurality of locations.

A user response logic, e.g. user response logic 150, may then be configured to determine a respective emotional response to the relevant content for each respective user. Each respective emotional response may be determined based, at least in part, on respective user objective data. Each respective emotional response may then be associated with a provided content identifier, a selected user identifier, selected user metadata, a provided time indicator corresponding to a respective point in time that the relative content was provided to the selected user and a respective location identifier. Thus, a respective user emotional response, provided content identifier, selected user identifier, selected user metadata, a time indicator, and a location indicator may be stored for each user of the plurality of users that was exposed to the provided content. Such information may be stored in, for example, data store 148. The respective user emotional response, etc., may be utilized by, e.g., group response logic 120 to update the respective user profile included in user profiles 144.

Group response logic 120 may then be configured to determine based, at least in part, on a selected user profile, whether the selected user of the selected group of users has given permission to share (i.e., aggregate) the selected user emotional response. For example, whether or not the user would be prepared or not to aggregate her/his emotional response with that of other users may be determined via a direct feedback loop (e.g. pop up or email request) and/or based, at least in part, on previously logged preferences/behaviors and/or a user-determined policy.

Group response logic 120 may then be configured to aggregate a plurality of emotional responses of a plurality of users to yield an aggregated emotional response. In one nonlimiting example, the aggregated emotional response may correspond to a range of emotional response values, e.g., one to ten, with one corresponding to very negative and ten corresponding to very positive. The aggregated emotional response may then be associated with the provided content identifier and stored in data store 148. In some embodiments, the aggregated emotional response and associated provided content identifier may be further associated with one or more of an aggregated time indicator, a plurality of individual time indicators, and/or one or more location identifiers. Each individual time indicator is configured to represent the point in time that the corresponding user was exposed to the provided content. The aggregated time indicator is configured to represent an aggregation of a plurality of points in time that a corresponding plurality of users were exposed to the provided content.

Group response logic 120 may then be configured to provide a selected aggregated emotional response to a request from a requesting user device, e.g., user device 104, for display to a requesting user. In an embodiment, group response logic 120 may be configured to determine whether a minimum number (e.g., at least two) individual user emotional responses is included in the aggregated emotional response. If not, the requested aggregated emotional response may not be provided to the requesting user. If the minimum number of individual user emotional responses is included in the requested aggregated emotional response, the requested aggregated emotional response may be displayed as one or more of an overlay over the corresponding provided content, an emoticon, a pie chart, a bar graph, a line graph, a heat map overlaying the corresponding provided content, etc. For example, a heat map overlay may include one or more colors configured to indicate a distribution of the intensity of aggregated user emotional response as well as valence (i.e. positive or negative) of the aggregated emotional response over the corresponding provided content. In one embodiment, the displayed aggregated emotional response may correspond to a subset of the aggregated emotional response. In one nonlimiting example, the subset may be identified based, at least in part, on metadata (e.g., content metadata and/or user metadata) stored in, e.g., data store 148. The subset may be related to one or more of a time of exposure to the provided content, a range of times of exposure to the provided content, characteristics of members of a subgroup of the group of users whose emotional responses are included in the aggregated emotional response, a location of exposure to the provided content, a range of locations of exposure to the provided content, a sentiment of emotional response (e.g., positive, negative, neutral), an intensity or range of intensities of emotional responses, etc.

In an embodiment, provided content may be categorized based, at least in part, on the associated aggregated emotional response. Categories may include, but are not limited to, content associated with a range of most negative emotional responses over a time period, content associated with a range of most positive emotional responses over time period, emotional responses to content with common characteristics (e.g., news articles, news feeds, sporting events, etc.). Thus, a user may be able to visualize how an aggregated emotional response to a specific content changed over time, group variability by emotion, etc.

In some embodiments, the content may be provided to the requesting user annotated with a link to the aggregated emotional response.

In an embodiment, one or more users may be offered an opt-in option. For example, system 100 may be configured to aggregate individual emotional responses to diverse types of provided content. The aggregated emotional responses may then be made available and searchable to any user that opted-in from a broader community. Any user may contribute with personal data, and receive something of value in return. Users of the system would be able to cut and visualize aggregated data according to diverse themes of interest. For instance, a user could leverage the system to learn about a new neighborhood before purchasing a new house or would be able to get a representation according to a specific user type (e.g., females, age range (e.g., 18-30 yo), locals, etc.). In this specific usage, group response logic 120 may be configured to anonymize user response data, unless the user specifically indicated otherwise, e.g., by a user policy in user profiles 144.

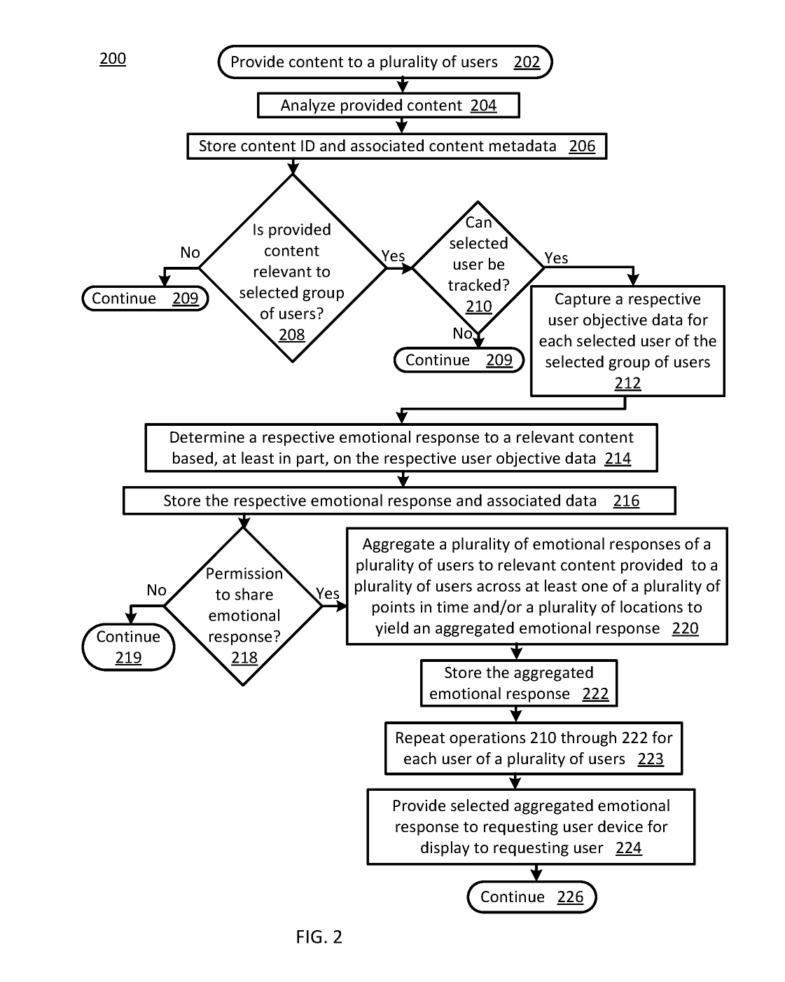

FIG. 2 is a flowchart 200 of group emotional response operations according to various embodiments of the provide disclosure. In particular, the flowchart 200 illustrates determining a group emotional response to relevant provided content, the relevant content provided to a plurality of users across at least one of a plurality of points in time and/or a plurality of locations. The operations may be performed, for example, by host device 102, user device 104 and/or environment device 106 of FIG. 1.

Operations of this embodiment may begin with presenting content to a plurality of users 202. Provided content may be analyzed at operation 204. A content identifier and associated content metadata may be stored at operation 206. Operation 208 may include determining whether the provided content is relevant to a selected group of users of the plurality of users. If the provided content is not relevant to the selected group of users of the plurality of users, program flow may continue at operation 209. If the provided content is relevant to the selected group of users, whether a selected user of the selected group of users can be tracked may be determined at operation 210. If the selected user cannot be tracked, program flow may continue at operation 211. If the selected user can be tracked, operation 212 may include capturing a respective user objective data for each selected user of the selected group of users in response to exposure to the relevant content. The relevant content is configured to be provided to the selected group of users across at least one of a plurality of points in time and/or a plurality of locations.

Operation 214 includes determining a respective emotional response to the relevant content for each respective user based, at least in part, on the respective user objective data. The respective selected user emotional response and associated data may be stored at operation 216. Associated data may include, but is not limited to, the provided content identifier, selected user identifier, selected user metadata, a provided time indicator corresponding to a respective point in time that the relevant content was provided to the selected user and a respective user location identifier. Whether a selected user of the selected group of users has given permission to share the selected user emotional response may be determined at operation 218. Permission may be determined based, at least in part, on the selected user user profile. If the selected user has not given permission to share the selected user emotional response, program flow may continue at operation 219. If the selected user has given permission to share the selected user's emotional response, a plurality of emotional responses of a plurality of users may be aggregated to yield an aggregated emotional response at operation 220. The plurality of users are configured to have been exposed to the relevant provided content across at least one of a plurality of points in time and/or a plurality of locations. The aggregated emotional response may be stored at operation 222. The aggregated emotional response may be associated with the provided content identifier, an aggregated time indicator related to at least one provided time indicator and one or more location identifiers. Operation 223 includes repeating operations 210 through 222 for each user of a plurality of users. Operation 224 may include providing a selected aggregated emotional response to a requesting user device for display to a requesting user. In some embodiments, the selected aggregated emotional response may be combined with the relevant content, e.g., as an overlay. Program flow may then continue at operation 226.

Thus, a group emotional response may be determined to provided content across at least one of a plurality of points in time and/or a plurality of locations.

While the flowchart of FIG. 2 illustrates operations according various embodiments, it is to be understood that not all of the operations depicted in FIG. 2 are necessary for other embodiments. In addition, it is fully contemplated herein that in other embodiments of the provide disclosure, the operations depicted in FIG. 2 and/or other operations described herein may be combined in a manner not specifically shown in any of the drawings, and such embodiments may include less or more operations than are illustrated in FIG. 2 Thus, claims directed to features and/or operations that are not exactly shown in one drawing are deemed within the scope and content of the provide disclosure.

Thus, a plurality of user emotional responses to relevant provided content may be determined based, at least in part, on respective user objective data. The plurality of users may be exposed to the relevant provided content across at least one of a plurality of points in time and/or a plurality of locations. An aggregated emotional response may be determined based, at least in part, on the plurality of user emotional responses. The aggregated emotional response may then be viewed by one or more requesting users.

As used in any embodiment herein, the term “logic” may refer to an app, software, firmware and/or circuitry configured to perform any of the aforementioned operations. Software may be embodied as a software package, code, instructions, instruction sets and/or data recorded on non-transitory computer readable storage medium. Firmware may be embodied as code, instructions or instruction sets and/or data that are hard-coded (e.g., nonvolatile) in memory devices.

“Circuitry”, as used in any embodiment herein, may comprise, for example, singly or in any combination, hardwired circuitry, programmable circuitry such as computer processors comprising one or more individual instruction processing cores, state machine circuitry, and/or firmware that stores instructions executed by programmable circuitry. The logic may, collectively or individually, be embodied as circuitry that forms part of a larger system, for example, an integrated circuit (IC), an application-specific integrated circuit (ASIC), a system on-chip (SoC), desktop computers, laptop computers, tablet computers, servers, smart phones, etc.

The foregoing provides example system architectures and methodologies, however, modifications to the provide disclosure are possible. The processor may include one or more processor cores and may be configured to execute system software. System software may include, for example, an operating system. Device memory may include I/O memory buffers configured to store one or more data packets that are to be transmitted by, or received by, a network interface.

The operating system (OS) may be configured to manage system resources and control tasks that are run on, e.g., host device 102, user device 104 and/or environment device 106. For example, the OS may be implemented using Microsoft® Windows®, HP-UX®, Linux®, or UNIX®, although other operating systems may be used. In another example, the OS may be implemented using Android™, iOS, Windows Phone® or BlackBerry®. In some embodiments, the OS may be replaced by a virtual machine monitor (or hypervisor) which may provide a layer of abstraction for underlying hardware to various operating systems (virtual machines) running on one or more processing units. The operating system and/or virtual machine may implement one or more protocol stacks. A protocol stack may execute one or more programs to process packets. An example of a protocol stack is a TCP/IP (Transport Control Protocol/Internet Protocol) protocol stack comprising one or more programs for handling (e.g., processing or generating) packets to transmit and/or receive over a network.

Memory circuitry 112-1, 112-2, 112-3 may each include one or more of the following types of memory: semiconductor firmware memory, programmable memory, nonvolatile memory, read only memory, electrically programmable memory, random access memory, flash memory, magnetic disk memory, and/or optical disk memory. Either additionally or alternatively system memory may include other and/or later-developed types of computer-readable memory.

Embodiments of the operations described herein may be implemented in a computer-readable storage device having stored thereon instructions that when executed by one or more processors perform the methods. The processor may include, for example, a processing unit and/or programmable circuitry. The storage device may include a machine readable storage device including any type of tangible, non-transitory storage device, for example, any type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, magnetic or optical cards, or any type of storage devices suitable for storing electronic instructions.

In some embodiments, a hardware description language (HDL) may be used to specify circuit and/or logic implementation(s) for the various logic and/or circuitry described herein. For example, in one embodiment the hardware description language may comply or be compatible with a very high speed integrated circuits (VHSIC) hardware description language (VHDL) that may enable semiconductor fabrication of one or more circuits and/or logic described herein. The VHDL may comply or be compatible with IEEE Standard 1076-1987, IEEE Standard 1076.2, IEEE1076.1, IEEE Draft 3.0 of VHDL-2006, IEEE Draft 4.0 of VHDL-2008 and/or other versions of the IEEE VHDL standards and/or other hardware description standards.

### EXAMPLES

Examples of the provide disclosure include subject material such as a method, means for performing acts of the method, a device, or of an apparatus or system related to representation of group emotional response, as discussed below.

### Example 1

According to this example, there is provided an apparatus. The apparatus includes a group response logic. The group response logic is to determine a respective user emotional response to a relevant content provided to each user of a plurality of users. The respective emotional response is determined based, at least in part, on a respective user objective data captured for each user in response to exposure of each user to the relevant provided content. The relevant content is provided to at least some of the plurality of users across at least one of a plurality of points in time and/or a plurality of locations. The group response logic is further to aggregate a plurality of respective user emotional responses to yield a first aggregated emotional response.

### Example 2

This example includes the elements of example 1, wherein the group response logic is further to provide a selected aggregated emotional response to a requesting user device for display to a requesting user.

### Example 3

This example includes the elements of example 1, wherein the group response logic is further to determine whether the provided content is relevant to a selected group of users.

### Example 4

This example includes the elements of example 1, wherein the group response logic is further to determine whether at least one of the respective user objective data and/or emotional response can be tracked.

### Example 5

This example includes the elements according to any one of examples 1 through 4, wherein the group response logic is further to determine based, at least in part, on a selected user profile, whether a selected user has given permission to share a selected user emotional response to the provided relevant content.

### Example 6

This example includes the elements according to any one of examples 1 through 4, wherein the provided content is selected from the group including audio content, one or more images, text, video content, a webpage, online content, an electronic document, an electronic presentations, a blog and/or a live content.

### Example 7

This example includes the elements of example 3, wherein the selected group of users is selected from the group including coworkers, members of a social media group, an email thread, a group list, a social group membership list, a social media group thread, a formal online-based group and/or a formal online-based association.

### Example 8

This example includes the elements according to any one of examples 1 through 4, wherein the content is experienced live by at least one user.

### Example 9

This example includes the elements of example 2, wherein the selected aggregated emotional response is displayed as one or more of an overlay over the content, an emoticon, a pie chart, a bar graph, a line graph and/or a heat map.

### Example 10

This example includes the elements of example 2, wherein the selected aggregated emotional response corresponds to at least a portion of the first aggregated emotional response.

### Example 11

According to this example, there is provided a method. The method includes determining, by a group response logic, a respective user emotional response to a relevant content provided to each user of a plurality of users. The respective emotional response is determined based, at least in part, on a respective user objective data captured for each user in response to exposure of each user to the relevant provided content. The relevant content is provided to at least some of the plurality of users across at least one of a plurality of points in time and/or a plurality of locations. The method further includes aggregating, by the group response logic, a plurality of respective user emotional responses to yield a first aggregated emotional response.

### Example 12

This example includes the elements of example 11, further including providing, by the group response logic, a selected aggregated emotional response to a requesting user device for display to a requesting user.

### Example 13

This example includes the elements of example 11, further including determining, by the group response logic, whether the provided content is relevant to a selected group of users.

### Example 14

This example includes the elements of example 11, further including determining, by the group response logic, whether at least one of the respective user objective data and/or emotional response can be tracked.

### Example 15

This example includes the elements of example 11, further including determining, by the group response logic, based, at least in part, on a selected user profile, whether a selected user has given permission to share a selected user emotional response to the provided relevant content.

### Example 16

This example includes the elements of example 11, wherein the provided content is selected from the group including audio content, one or more images, text, video content, a webpage, online content, an electronic document, an electronic presentations, a blog and/or a live content.

### Example 17

This example includes the elements of example 13, wherein the selected group of users is selected from the group including coworkers, members of a social media group, an email thread, a group list, a social group membership list, a social media group thread, a formal online-based group and/or a formal online-based association.

### Example 18

This example includes the elements of example 11, wherein the content is experienced live by at least one user.

### Example 19

This example includes the elements of example 12, wherein the selected aggregated emotional response is displayed as one or more of an overlay over the content, an emoticon, a pie chart, a bar graph, a line graph and/or a heat map.

### Example 20

This example includes the elements of example 12, wherein the selected aggregated emotional response corresponds to at least a portion of the first aggregated emotional response.

### Example 21

According to this example, there is provided a system. The system includes a processor circuitry; a communication circuitry; a group profiles; and a group response logic. The group response logic is to determine a respective user emotional response to a relevant content provided to each user of a plurality of users. The respective emotional response is determined based, at least in part, on a respective user objective data captured for each user in response to exposure of each user to the relevant provided content. The relevant content is provided to at least some of the plurality of users across at least one of a plurality of points in time and/or a plurality of locations. The group response logic is further to aggregate a plurality of respective user emotional responses to yield a first aggregated emotional response.

### Example 22

This example includes the elements of example 21, wherein the group response logic is further to provide a selected aggregated emotional response to a requesting user device for display to a requesting user.

### Example 23

This example includes the elements of example 21, wherein the group response logic is further to determine whether the provided content is relevant to a selected group of users.

### Example 24

This example includes the elements of example 21, wherein the group response logic is further to determine whether at least one of the respective user objective data and/or emotional response can be tracked.

### Example 25

This example includes the elements according to any one of examples 21 through 24, wherein the group response logic is further to determine based, at least in part, on a selected user profile, whether a selected user has given permission to share a selected user emotional response to the provided relevant content.

### Example 26

This example includes the elements according to any one of examples 21 through 24, wherein the provided content is selected from the group including audio content, one or more images, text, video content, a webpage, online content, an electronic document, an electronic presentations, a blog and/or a live content.

### Example 27

This example includes the elements of example 23, wherein the selected group of users is selected from the group including coworkers, members of a social media group, an email thread, a group list, a social group membership list, a social media group thread, a formal online-based group and/or a formal online-based association.

### Example 28

This example includes the elements according to any one of examples 21 through 24, wherein the content is experienced live by at least one user.

### Example 29

This example includes the elements of example 22, wherein the selected aggregated emotional response is displayed as one or more of an overlay over the content, an emoticon, a pie chart, a bar graph, a line graph and/or a heat map.

### Example 30

This example includes the elements of example 22, wherein the selected aggregated emotional response corresponds to at least a portion of the first aggregated emotional response.

### Example 31

According to this example, there is provided a computer readable storage device. The device has stored thereon instructions that when executed by one or more processors result in the following operations including: determining a respective user emotional response to a relevant content provided to each user of a plurality of users. The respective emotional response is determined based, at least in part, on a respective user objective data captured for each user in response to exposure of each user to the relevant provided content. The relevant content is provided to at least some of the plurality of users across at least one of a plurality of points in time and/or a plurality of locations. The operations further include aggregating a plurality of respective user emotional responses to yield a first aggregated emotional response.

### Example 32

This example includes the elements of example 31, wherein the instructions that when executed by one or more processors results in the following additional operations including providing a selected aggregated emotional response to a requesting user device for display to a requesting user.

### Example 33

This example includes the elements of example 31, wherein the instructions that when executed by one or more processors results in the following additional operations including determining whether the provided content is relevant to a selected group of users.

### Example 34

This example includes the elements of example 31, wherein the instructions that when executed by one or more processors results in the following additional operations including determining whether at least one of the respective user objective data and/or emotional response can be tracked.

### Example 35

This example includes the elements according to any one of examples 31 to 34, wherein the instructions that when executed by one or more processors results in the following additional operations including determining based, at least in part, on a selected user profile, whether a selected user has given permission to share a selected user emotional response to the provided relevant content.

### Example 36

This example includes the elements according to any one of examples 31 to 34, wherein the provided content is selected from the group including audio content, one or more images, text, video content, a webpage, online content, an electronic document, an electronic presentations, a blog and/or a live content.

### Example 37

This example includes the elements of example 33, wherein the selected group of users is selected from the group including coworkers, members of a social media group, an email thread, a group list, a social group membership list, a social media group thread, a formal online-based group and/or a formal online-based association.

### Example 38

This example includes the elements according to any one of examples 31 to 34, wherein the content is experienced live by at least one user.

### Example 39

This example includes the elements of example 32, wherein the selected aggregated emotional response is displayed as one or more of an overlay over the content, an emoticon, a pie chart, a bar graph, a line graph and/or a heat map.

### Example 40

This example includes the elements of example 32, wherein the selected aggregated emotional response corresponds to at least a portion of the first aggregated emotional response.

### Example 41

According to this example, there is provided a device. The device includes means for determining, by a group response logic, a respective user emotional response to a relevant content provided to each user of a plurality of users. The respective emotional response is determined based, at least in part, on a respective user objective data captured for each user in response to exposure of each user to the relevant provided content. The relevant content is provided to at least some of the plurality of users across at least one of a plurality of points in time and/or a plurality of locations. The device further includes means for aggregating, by the group response logic, a plurality of respective user emotional responses to yield a first aggregated emotional response.

### Example 42

This example includes the elements of example 41, further including means for providing, by the group response logic, a selected aggregated emotional response to a requesting user device for display to a requesting user.

### Example 43

This example includes the elements of example 41, further including means for determining, by the group response logic, whether the provided content is relevant to a selected group of users.

### Example 44

This example includes the elements of example 41, further including means for determining, by the group response logic, whether at least one of the respective user objective data and/or emotional response can be tracked.

### Example 45

This example includes the elements according to any one of examples 41 to 44, further including means for determining, by the group response logic, based, at least in part, on a selected user profile, whether a selected user has given permission to share a selected user emotional response to the provided relevant content.

### Example 46

This example includes the elements according to any one of examples 41 to 44, wherein the provided content is selected from the group including audio content, one or more images, text, video content, a webpage, online content, an electronic document, an electronic presentations, a blog and/or a live content.

### Example 47

This example includes the elements of example 43, wherein the selected group of users is selected from the group including coworkers, members of a social media group, an email thread, a group list, a social group membership list, a social media group thread, a formal online-based group and/or a formal online-based association.

### Example 48

This example includes the elements according to any one of examples 41 to 44, wherein the content is experienced live by at least one user.

### Example 49

This example includes the elements of example 42, wherein the selected aggregated emotional response is displayed as one or more of an overlay over the content, an emoticon, a pie chart, a bar graph, a line graph and/or a heat map.

### Example 50

This example includes the elements of example 42, wherein the selected aggregated emotional response corresponds to at least a portion of the first aggregated emotional response.

### Example 51

According to this example, there is provided a system. The system includes at least one device arranged to perform the method of any one of examples 11 to 20.

### Example 52

According to this example, there is provided a device. The device includes means to perform the method of any one of examples 11 to 20.

### Example 53

According to this example, there is provided a computer readable storage device. The device has stored thereon instructions that when executed by one or more processors result in the following operations including: the method according to any one of examples 11 to 20.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

Various features, aspects, and embodiments have been described herein. The features, aspects, and embodiments are susceptible to combination with one another as well as to variation and modification, as will be understood by those having skill in the art. The provide disclosure should, therefore, be considered to encompass such combinations, variations, and modifications.

What is claimed is:

1. An apparatus comprising:
a group response logic to determine a respective user emotional response to a relevant content provided to each user of a plurality of users, the respective emotional response determined based, at least in part, on a respective user objective data captured for each user in response to exposure of each user to the relevant provided content,
the relevant content provided to at least some of the plurality of users across at least one of a plurality of points in time and/or a plurality of locations,
the group response logic further to aggregate a plurality of respective user emotional responses to yield a first aggregated emotional response.

2. The apparatus of claim 1, wherein the group response logic is further to provide a selected aggregated emotional response to a requesting user device for display to a requesting user.

3. The apparatus of claim 1, wherein the group response logic is further to determine whether the provided content is relevant to a selected group of users.

4. The apparatus of claim 1, wherein the group response logic is further to determine whether at least one of the respective user objective data and/or emotional response can be tracked.

5. The apparatus of claim 1, wherein the group response logic is further to determine based, at least in part, on a selected user profile, whether a selected user has given permission to share a selected user emotional response to the provided relevant content.

6. The apparatus of claim 2, wherein the selected aggregated emotional response is displayed as one or more of an overlay over the content, an emoticon, a pie chart, a bar graph, a line graph and/or a heat map.

7. The apparatus of claim 2, wherein the selected aggregated emotional response corresponds to at least a portion of the first aggregated emotional response.

8. A method comprising:
determining, by a group response logic, a respective user emotional response to a relevant content provided to each user of a plurality of users, the respective emotional response determined based, at least in part, on a respective user objective data captured for each user in response to exposure of each user to the relevant provided content, the relevant content provided to at least some of the plurality of users across at least one of a plurality of points in time and/or a plurality of locations; and
aggregating, by the group response logic, a plurality of respective user emotional responses to yield a first aggregated emotional response.

9. The method of claim 8, further comprising providing, by the group response logic, a selected aggregated emotional response to a requesting user device for display to a requesting user.

10. The method of claim 8, further comprising determining, by the group response logic, whether the provided content is relevant to a selected group of users.

11. The method of claim 8, further comprising determining, by the group response logic, whether at least one of the respective user objective data and/or emotional response can be tracked.

12. The method of claim 8, further comprising determining, by the group response logic, based, at least in part, on a selected user profile, whether a selected user has given permission to share a selected user emotional response to the provided relevant content.

13. The method of claim 9, wherein the selected aggregated emotional response is displayed as one or more of an overlay over the content, an emoticon, a pie chart, a bar graph, a line graph and/or a heat map.

14. The method of claim 9, wherein the selected aggregated emotional response corresponds to at least a portion of the first aggregated emotional response.

15. A system comprising:
a processor circuitry;
a communication circuitry;
a group profiles; and
a group response logic to determine a respective user emotional response to a relevant content provided to each user of a plurality of users, the respective emotional response determined based, at least in part, on a respective user objective data captured for each user in response to exposure of each user to the relevant provided content,
the relevant content provided to at least some of the plurality of users across at least one of a plurality of points in time and/or a plurality of locations,
the group response logic further to aggregate a plurality of respective user emotional responses to yield a first aggregated emotional response.

16. The system of claim 15, wherein the group response logic is further to provide a selected aggregated emotional response to a requesting user device for display to a requesting user.

17. The system of claim 15, wherein the group response logic is further to determine whether the provided content is relevant to a selected group of users.

18. The system of claim 15, wherein the group response logic is further to determine whether at least one of the respective user objective data and/or emotional response can be tracked.

19. The system of claim 15, wherein the group response logic is further to determine based, at least in part, on a selected user profile, whether a selected user has given permission to share a selected user emotional response to the provided relevant content.

20. The system of claim 16, wherein the selected aggregated emotional response is displayed as one or more of an overlay over the content, an emoticon, a pie chart, a bar graph, a line graph and/or a heat map.

21. The system of claim 16, wherein the selected aggregated emotional response corresponds to at least a portion of the first aggregated emotional response.
